(19) United States
(12) Patent Application Publication
(10) Pub. No.: US 2014/0317602 A1
(43) Pub. Date: Oct. 23, 2014

(54) Graphical User Interface Debugger with User Defined Interest Points

(71) Applicant: INTERNATIONAL BUSINESS MACHINES CORPORATION, Armonk, NY (US)

(72) Inventor: Ying Zuo, San Jose, CA (US)

(73) Assignee: International Business Machines Corporation, Armonk, NY (US)

(21) Appl. No.: 13/866,184

(22) Filed: Apr. 19, 2013

(51) Int. Cl. G06F 11/36

(52) U.S. Cl. CPC G06F 11/3636
USPC 717/125

(57) ABSTRACT

A mechanism is provided in a data processing system for debugging a web application. The mechanism loads a web application having a plurality of source code files in a browser with an associated debugger executing in the data processing system. Responsive to receiving user selection of a record function, the debugger records user actions and changes in the source code files to a recording file. The mechanism replays the recording file in the browser and presenting debug information to the user in panels of the debugger.

### BACKGROUND

The present application relates generally to an improved data processing apparatus and method and more specifically to mechanisms for collecting debug data in a secure chip implementation.

A graphical user interface (GUI) is a type of user interface that allows users to interact with electronic devices using images rather than text commands. GUIs can be used in computers, hand-held devices, and web applications. A GUI represents the information and actions available to a user through graphical icons and visual indicators such as secondary notation, as opposed to text-based interfaces, typed command labels or text navigation. The actions are usually performed through direct manipulation of the graphical elements.

A web application is an application that is accessed by users over a network such as the Internet or an intranet. The term may also mean a computer software application that is coded in a browser-supported programming language, such as JavaScript™ combined with a browser-rendered markup language like hypertext markup language (HTML), and reliant on a common web browser to render the application executable. JAVASCRIPT is a trademark of Oracle Corporation in the United States and other countries.

Web applications are popular due to the ubiquity of web browsers, and the convenience of using a web browser as a client, sometimes called a thin client. The ability to update and maintain web applications without distributing and installing software on potentially thousands of client computers is a key reason for their popularity, as is the inherent support for cross-platform compatibility. Common web applications include webmail, online retail sales, online auctions, wilds and many other functions.

A debugger or debugging tool is a computer program that is used to test and debug other programs (the “target” program). A “crash” happens when the program cannot normally continue because of a programming bug. When the program crashes or reaches a preset condition, the debugger typically shows the location in the original code if it is a source-level debugger or symbolic debugger, commonly now seen in integrated development environments. If it is a low-level debugger or a machine-language debugger it shows the line in the disassembly, unless it also has online access to the original source code and can display the appropriate section of code from the assembly or compilation.

White-box testing, also known as clear box testing, glass box testing, transparent box testing, and structural testing, is a method of testing software that tests internal structures or workings of an application, as opposed to its functionality (i.e., black-box testing). In white-box testing an internal perspective of the system and programming skills are used to design test cases. The tester chooses inputs to exercise paths through the code and determine the appropriate outputs. This is analogous to testing nodes in a circuit, e.g. in-circuit testing (ICT).

While white-box testing can be applied at the unit, integration and system levels of the software testing process, it is usually done at the unit level. White-box testing can test paths within a unit, paths between units during integration, and between subsystems during a system-level test. Although this method of test design can uncover many errors or problems, it might not detect unimplemented parts of the specification or missing requirements.

### SUMMARY

In one illustrative embodiment, a method, in a data processing system, is provided for debugging a web application. The method comprises loading a web application having a plurality of source code files in a browser with an associated debugger executing in the data processing system. The method further comprises responsive to receiving user selection of a record function, recording, by the debugger, user actions and changes in the source code files to a recording file. The method further comprises replaying the recording file in the browser and presenting debug information to the user in panels of the debugger.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 is a block diagram of an example data processing system in which aspects of the illustrative embodiments may be implemented;

FIGS. 3A and 313 are block diagrams of a mechanism for an enhanced application debugger in accordance with an illustrative embodiment;

FIG. 4 depicts an example screen of display for a debug session in accordance with an illustrative embodiment;

FIGS. 5A and 5B depict an example screen of display for a debug session with user action recording in accordance with an illustrative embodiment;

FIG. 6 is a flowchart illustrating operation of a mechanism for recording a debug session in accordance with an illustrative embodiment; and

FIG. 7 is a flowchart illustrating operation of a mechanism for using a debug session recording in accordance with an illustrative embodiment.

### DETAILED DESCRIPTION

The illustrative embodiments provide a mechanism for an enhanced graphical user interface (GUI) debugger that allows developers to record and play the debugging process with an option to break on files with breakpoints only. The mechanism facilitates developers to analyze code efficiency by allowing developers to set timers in the source code directly. The mechanism records user actions on a GUI application and plays the user actions such that all changes can be viewed on the debugger. The changes may include element attribute changes, functions that get called, and call stacks of those functions. The debugger generates a general script or text file for the recording that will be understood by the debugger such that it can be shared with others. The mechanism provides an option to break on files with breakpoints only so the debugger will only stop in the interested files with a step-into-action function to go through code line-by-line. The mechanism allows the user to set the start and end point of timers in the source code panel in the debugger.

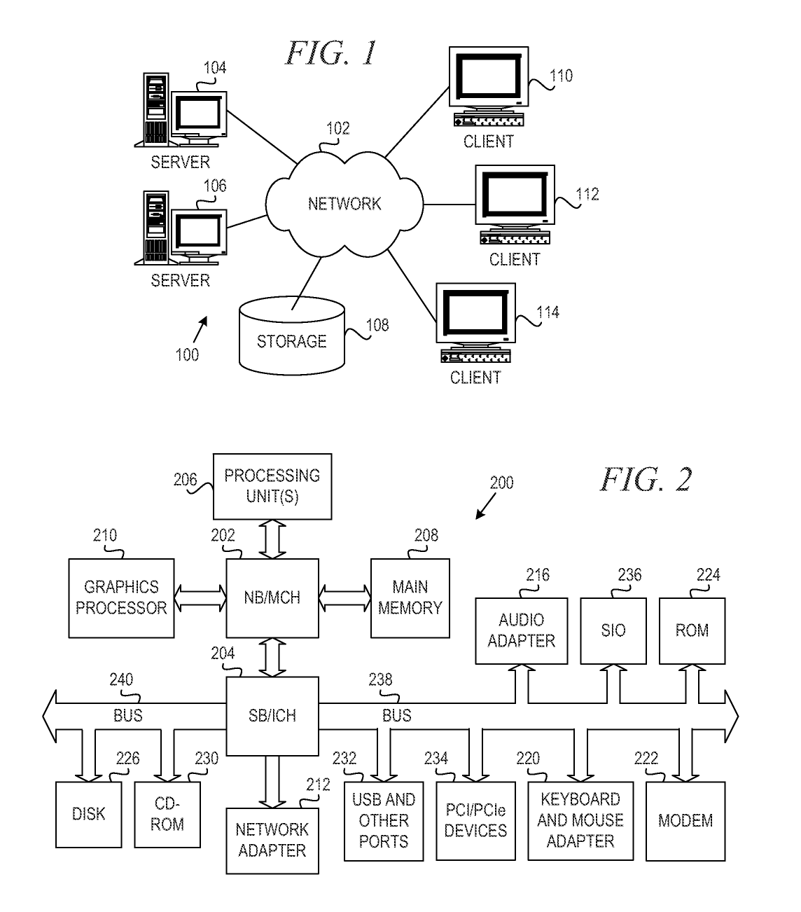

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

In accordance with an illustrative embodiment, server 104 may host a web-based application that is accessed by clients 110, 112, 114. In one example embodiment, client 110 runs a GUI debugger that helps front-end developers to find cause of defects during client-side software execution of the web-based application. Today's software has become more and more complicated. Simply allowing users to set breakpoints is not enough to isolate bugs, because the problem may arise only under a set of specific instructions continually without breaking at any points in between. For example, a tabbing issue may only occur the third time the element is visited, and the developer cannot set the break point on the element because it will lose focus if the focus moves to the breakpoint.

Repeating the same process on the GUI manually to trigger the breakpoint is time-consuming. Existing debuggers provide tools to measure the overall performance of an application but not at the source code level. Developers must add temporary code to perform white-box performance testing manually in multiple places of the source code.

The illustrative embodiments provide an enhanced application debugger that allows developers to record and play the debugging process. The enhanced application debugger provides an option to break on files with breakpoints only. The debugger also allows developers to analyze code efficiency by allowing them to set timers in the source code directly.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows 7 (Microsoft and Windows are trademarks of Microsoft Corporation in the United States, other countries, or both). An object-oriented programming system, such as the Java programming system, may run in conjunction with the operating system and provides calls to the operating system from Java programs or applications executing on data processing system 200 (Java is a trademark of Oracle and/or its affiliates.).

As a server, data processing system 200 may be, for example, an IBM® eServer™ System p® computer system, running the Advanced Interactive Executive (AIX®) operating system or the LINUX operating system (IBM, eServer, System p, and AIX are trademarks of International Business Machines Corporation in the United States, other countries, or both, and LINUX is a registered trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in Ha 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, min memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

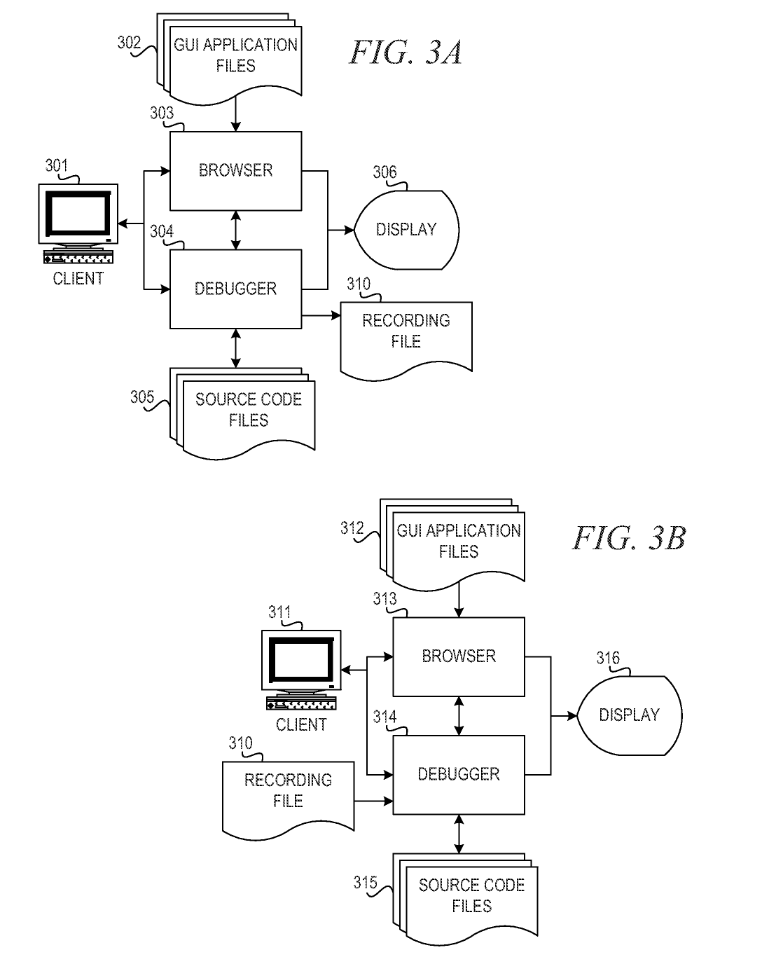

FIGS. 3A and 313 are block diagrams of a mechanism for an enhanced application debugger in accordance with an illustrative embodiment. With reference to FIG. 3A, browser 303 and debugger 304 execute on client data processing system 301. Browser 303 executes a web application using graphical user interface (GUI) application files 302 and presents the GUI for the web application on display 306. In one embodiment, debugger 304 may be a component of browser 303.

Debugger 304 receives source code files 305. Debugger 304 presents one or more display panels regarding execution of the web application on display device 306. The panels may present, for example, the source code files 305 in the form of hypertext markup language (HTML) files, cascading style sheet (CSS) files, object oriented script files, document object model files, and so forth. The panels may also present further information, such as breakpoints, call stacks, etc.

In accordance with an illustrative embodiment, debugger 304 allows developers to record user actions on the web application executing within browser 303. Debugger 304 records the user actions and changes, such as element attribute changes, functions that are called, and call stacks of those functions, in recording file 310. Recording file 310 may be a script or text file. Thus, a user of debugger 304 may perform actions in the web application 302 using browser 303 to trigger a bug. The user can then replay the recording file 310 in debugger 304 and view the display from browser 303 and debugger 304 to analyze the source code files 305 in association with the recorded user actions and changes.

Debugger 304 provides an option to break on files with breakpoints. A user may set breakpoints in the source code files 305, and debugger 305 allows the user to either step over or step into each breakpoint. If the user chooses to step over a breakpoint, debugger 305 proceeds through the recorded actions until the next breakpoint is encountered. If the user chooses to step into a breakpoint, debugger 305 proceeds through the source code line-by-line, playing the recorded actions and presenting the panels of display on display device 306.

Debugger 304 allows a user to set start and end points of timers in the source code panel. Thus, the user may track performance of the web application. This provides an improvement over white-box testing, because the user can set timers in the debugger rather than having to go to the original source code files at the source. Debugger 304 may then calculate time spent on executing the statements of the web application to allow performance analysis.

Turning to FIG. 3B, browser 313 and debugger 314 execute on client data processing system 311. Browser 313 executes a web application using graphical user interface (GUI) application files 312 and presents the GUI for the web application on display 316. In one embodiment, debugger 314 may be a component of browser 313.

Debugger 314 receives source code files 315. Debugger 314 presents one or more display panels regarding execution of the web application on display device 316. The panels may present, for example, the source code files 315 in the form of hypertext markup language (HTML) files, cascading style sheet (CSS) files, object oriented script files, document object model files, and so forth. The panels may also present further information, such as breakpoints, call stacks, etc.

In accordance with an illustrative embodiment, debugger 314 receives recording file 310, which was recorded by another debugger, such as debugger 304 in FIG. 3A. That is, a tester using debugger 304 may perform user actions to trigger a bug and export the recording file 310 in a format that is understood by debugger 314. A user at client data processing system 311 may then import the recording file 310 into debugger 314 and replay the user actions on browser 313 to recreate the bug.

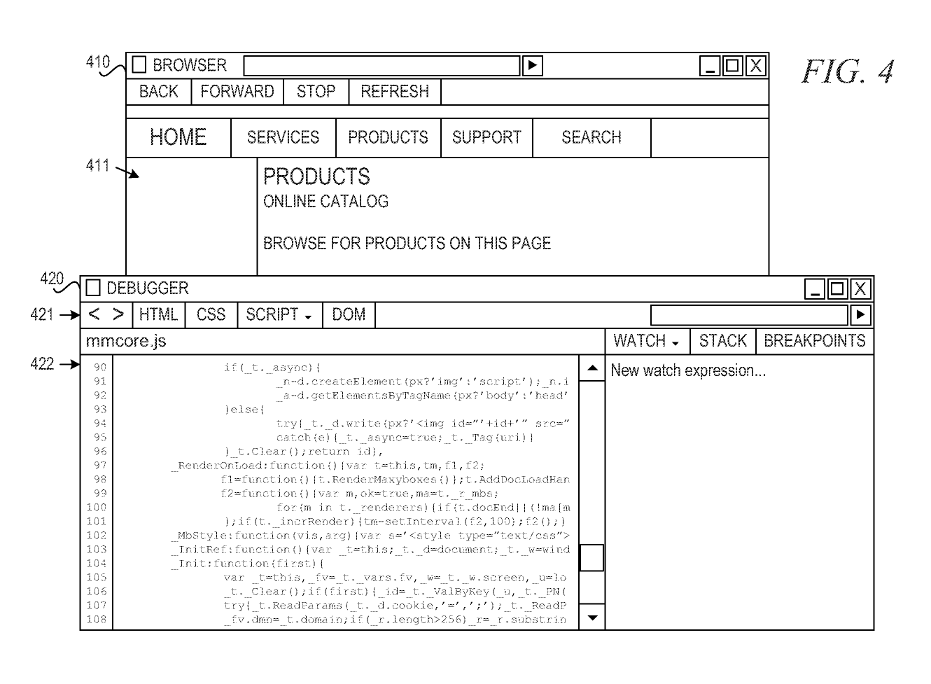

FIG. 4 depicts an example screen of display for a debug session in accordance with an illustrative embodiment. Browser window 410 presents a web browser executing a web application display area 411. Debugger window 420 presents debugging information in display areas, such as display panel 422. In the depicted example, display panel 422 presents a script file of the source code of the web application.

Debugger window 420 also includes breakpoint controls 421, which a low the user to go forward or backward in the execution of the web application within debugger 420 from one breakpoint to another. The user may also switch display panels to present a hypertext markup language (HTML) file, a cascading style sheets (CSS) file, or the like. Debugger 420 may present other information, such as breakpoints, events to watch for, call stack, etc.

Today's software has become more and more complicated. Simply allowing users to set breakpoints is not enough, because the problem may arise only under a set of specific instructions continually without breaking at any points in between. For example, a tabbing issue may only occur the third time the element is visited, and the developer cannot set the breakpoint on the element because the element will lose focus if the focus moves to the breakpoint.

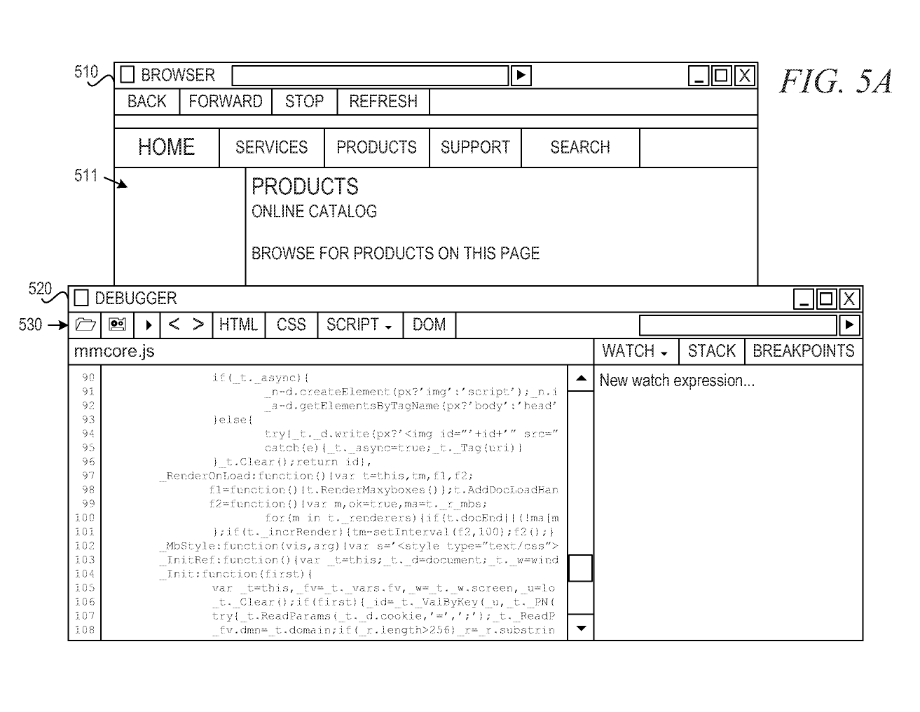

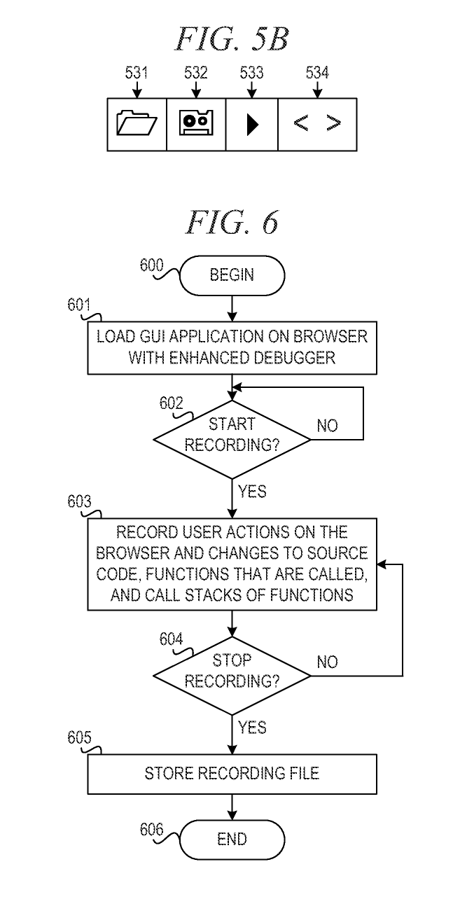

FIGS. 5A and 5B depict an example screen of display for a debug session with user action recording in accordance with an illustrative embodiment. With reference to FIG. 5A, browser window 510 presents a web browser executing a web application in display area 511. Debugger window 520 presents debugging information in display areas, such as display panel 522. In the depicted example, display panel 522 presents a script file of the source code of the web application.

In the illustrative embodiment, debugger window 520 includes recording controls 530. FIG. 5B depicts the recording controls in accordance with one example embodiment. Open control 531 allows the user to open or import a saved recording file from the same or a different debugger. Thus, the user may open a previous recording of a tester who recreated a bug. Record control 532 allows the user to record user actions and changes in the web application, such as element attribute changes, functions that get called, and call stacks of those functions. Play control 533 allows the user to play the recording.

The debugger may provide break on files with breakpoints only. The debugger may then break on only files with breakpoints. Breakpoint controls 534 allow the user to go forward or backward in the execution of the web application within debugger from one breakpoint to another. In one mode of operation, controls 534 may allow the user to step over, i.e., jump to the next breakpoint. In another mode of operation, controls 534 may allow the user to step into action, i.e., go through the code line-by-line.

A user loads the web application on a browser with the enhanced debugger of the illustrative embodiments. When the user gets to the interested panel, the user starts the recording on the debugger by selecting record control 532, for example. From this point, the debugger records every user action on the browser, as well as all changes in the source code, such as element attribute changes, functions that get called, and call stacks of those functions. Once the user successfully triggers the defect in the web application, the user can stop the recording and play the recording to see changes happen in different panels of the debugger, such as HTML, console, script, etc.

The user can set start points and end points of timers in the source code. They will be like the breakpoints, but the debugger will calculate and record time spent on executing the statement. The user can select the option to break on files with breakpoints only on the debugger so the user can skip stopping in the files without breakpoints, which are usually those third-patty code or other code that should not be included in the investigation.

A user can download the recording in a script or text format. The recording can be uploaded and executed in the debugger. The user can play the same recording repeatedly.

As will be appreciated by one skilled in the art, the present invention may be embodied as a system, method, or computer program product. Accordingly, aspects of the present invention may take the form of an entirety hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in any one or more computer readable medium(s) having computer usable program code embodied thereon.

Any combination of one or more computer readable medium(s) my be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (anon-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

FIG. 6 is a flowchart illustrating operation of a mechanism for recording a debug session in accordance with an illustrative embodiment. Operation begins (block 600), and the mechanism loads a graphical user interface (GUI) application in a web browser with enhanced debugging (block 601). The mechanism determines whether the user selects to start a recording (block 602). If the mechanism determines the user does not select to start a recording, operation returns to block 602 to determine whether the user selects to start a recording.

If the mechanism determines the user selects to start a recording in block 602, the mechanism records user actions on the browser and changes to source code, functions that are called, and call stacks of those functions (block 603). The mechanism then determines whether the user selects to stop the recording (block 604). If the mechanism determines the user does not select to stop the recording, operation returns to block 603 to record user actions on the browser and changes to source code, functions that are called, and call stacks of those functions.

If the mechanism determines the user selects to stop the recording in block 604, the mechanism stores the recording file (block 605). Thereafter, operation ends (block 606).

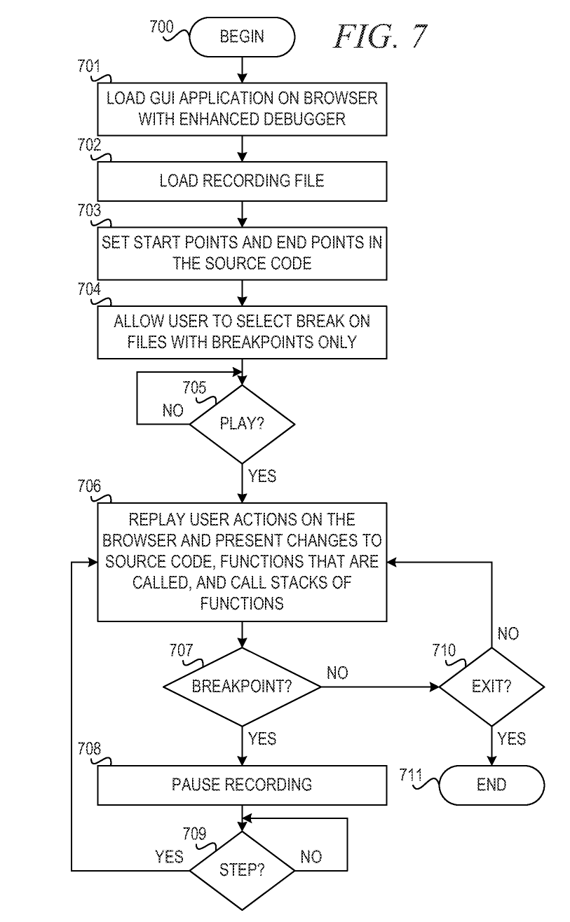

FIG. 7 is a flowchart illustrating operation of a mechanism for using a debug session recording in accordance with an illustrative embodiment. Operation begins (block 700), and the mechanism loads a graphical user interface (GUI) application in a web browser with enhanced debugging (block 701). The mechanism loads a recording file (block 702). The recording file may be from a previous recording on the debugger or may be imported from another client data processing system.

The user sets start points and end points of timers in the source code (block 703). The mechanism allows the user to select break on files with breakpoints only (block 704). The mechanism determines whether the user selects to play the recording file in the browser (block 705). If the user does not select to play the recording file, operation returns to block 705 to determine whether the user selects to play the recording file.

If the user selects to play the recording file in block 705, the mechanism replays user actions on the browser and presents changes to source code, functions that are called, and call stacks of those functions in panels of the debugger (block 706). The mechanism determines whether the user selects whether a breakpoint is reached (block 707). If a breakpoint is reached, the mechanism pauses the recording (block 708). The mechanism then determines whether the user selects to step over or step into action (block 709). If no selection, operation returns to block 709 until a selection is made.

In one mode of operation, if the user selects to stop over to the next breakpoint in block 709, operation returns to block 706 to replay user actions until the next breakpoint is encountered in block 707.

In another mode of operation, if the user selects to step into action in block 709, operation returns to block 706 to replay user actions line-by-line and present changes to source code, functions that are called, and call stacks of those functions. The user may then step through the code line-by-line until the next breakpoint is encountered in block 707.

If a breakpoint is not reached in block 707, the mechanism determines whether an exit condition exists (block 710). If an exit condition does not exist, operation returns to block 706 to replay user actions in either the step over mode of operation or the step into action mode of operation. If an exit condition exists in block 710, operation ends (block 711).

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide a mechanism for an enhanced graphical user interface (GUI) debugger that allows developers to record and play the debugging process with an option to break on files with breakpoints only. The mechanism facilitates developers to analyze code efficiency by allowing developers to set timers in the source code directly. The mechanism records user actions on a GUI application and plays the user actions such that all changes can be viewed on the debugger. The changes may include element attribute changes, functions that get called, and call stacks of those functions. The debugger generates a general script or text file for the recording that wilt be understood by the debugger such that it can be shared with others. The mechanism provides an option to break on files with breakpoints only so the debugger will only stop in the interested files with a step-into-action function to go through code line-by-line. The mechanism allows the user to set the start and end point of timers in the source code panel in the debugger.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for debugging a web application, the method comprising:
loading a web application having a plurality of source code files in a browser with an associated debugger executing in the data processing system;
responsive to receiving user selection of a record function, recording, by the debugger, user actions and changes in the source code files to a recording file; and
replaying the recording file in the browser and presenting debug information to the user in panels of the debugger.

2. The method of claim 1, wherein responsive to receiving user selection of a break on files with breakpoints only option, the debugger skips stopping on files without breakpoints.

3. The method of claim 1, further comprising:
receiving user input defining a start time and an end time of a timer; and
calculating time spent on executing at least one statement in the source code files using the timer.

4. The method of claim 1, wherein the changes in the source code files comprise element attribute changes, functions that get called, or call stacks of functions.

5. The method of claim 1, further comprising:
exporting the recording file, wherein a second debugger associated with a second browser executing in a second data processing system is configured to load the recording file and play the user actions in the second browser.

6. The method of claim 1, further comprising:
presenting, by the debugger, record and play controls; and
controlling recording and playing of the recording file based on user interaction with the record and play controls.

7. The method of claim 1, wherein replaying the recording file in the browser and presenting debug information to the user in panels of the debugger comprises:
responsive to reaching a breakpoint in the web application, stepping into the next breakpoint by going through the source code line-by-line.

8. A computer program product comprising a computer readable storage medium having a computer readable program stored therein, wherein the computer readable program, when executed on a computing device, causes the computing device to:
load a web application having a plurality of source code files in a browser with an associated debugger executing in the data processing system;
responsive to receiving user selection of a record function, record, by the debugger, user actions and changes in the source code files to a recording file; and
replay the recording file in the browser and presenting debug information to the user in panels of the debugger.

9. The computer program product of claim 8, wherein responsive to receiving user selection of a break on files with breakpoints only option, the debugger skips stopping on files without breakpoints.

10. The computer program product of claim 8, wherein the computer readable program further causes the computing device to:
receive user input defining a start time and an end time of a timer; and
calculate time spent on executing at least one statement in the source code files using the timer.

11. The computer program product of claim 8, wherein the changes in the source code files comprise element attribute changes, functions that get called, or call stacks of functions.

12. The computer program product of claim 8, wherein the computer readable program further causes the computing device to:
export the recording file, wherein a second debugger associated with a second browser executing in a second data processing system is configured to load the recording file and play the user actions in the second browser.

13. The computer program product of claim 8, wherein replaying the recording file in the browser and presenting debug information to the user in panels of the debugger comprises:
responsive to reaching a breakpoint in the web application, stepping into the next breakpoint by going through the source code line-by-line.

14. The computer program product of claim 8, wherein the computer readable program is stored in a computer readable storage medium in a data processing system and wherein the computer readable program was downloaded over a network from a remote data processing system.

15. The computer program product of claim 8, wherein the computer readable program is stored in a computer readable storage medium in a server data processing system and wherein the computer readable program is downloaded over a network to a remote data processing system for use in a computer readable storage medium with the remote system.

16. An apparatus, comprising:
a processor; and
a memory coupled to the processor, wherein the memory comprises instructions which, when executed by the processor, cause the processor to:
load a web application having a plurality of source code files in a browser with an associated debugger executing in the data processing system;
responsive to receiving user selection of a record function, record, by the debugger, user actions and changes in the source code files to a recording file; and
replay the recording file in the browser and presenting debug information to the user in panels of the debugger.

17. The apparatus of claim 16, wherein responsive to receiving user selection of a break on files with breakpoints only option, the debugger skips stopping on files without breakpoints.

18. The apparatus of claim 16, wherein the instructions further cause the processor to:
receive user input defining a start time and an end time of a timer; and
calculate time spent on executing at least one statement in the source code files using the tinier.

19. The apparatus of claim 16, wherein the changes in the source code files comprise element attribute changes, functions that get called, or call stacks of functions.

20. The apparatus of claim 16, wherein the instructions further cause the processor to:
export the recording file, wherein a second debugger associated with a second browser executing in a second data processing system is configured to load the recording file and play the user actions in the second browser.
